(19) United States
(12) Patent Application Publication
(10) Pub. No.: US 2003/0146838 A1
(43) Pub. Date: Aug. 7, 2003

(54) Activation and deactivation of magnetic components

(76) Inventors: David G Rhys Jones, Bristol (GB); Paul G Cox, Bristol (GB); Ronald B Easter, Parkland, FL (US)

Correspondence Address: Morris Liss, Connolly Bove Lodge & Hutz, Suite 800, 1990 M Street N W, Washington, DC, 20036-3425, US

(21) Appl. No.: 10/221,325

(22) PCT Filed: Mar. 16, 2001
(86) PCT No.: PCT/GB01/01187

(30) Foreign Application Priority Data
Mar. 17, 2000 (GB) 0006542.5
Jul. 31, 2000 (GB) 0018779.9

(51) Int. Cl. G08B 13/14

(52) U.S. Cl. 340/572.3; 340/572.6

(57) ABSTRACT

Magnetic security tags/labels require to be activated/deactivated by magnetic/demagnetization and to enable this to be effected in bulk, with tagged products packed in a crate or stacked on a pallet, the invention proposes the provision of bulk magnetization/demagnetization coils generating a powerful magnetic field which is applied to the crate or pallet with a particular orientation which ensures that regularly shaped (e.g. rectangular) packages packed/stacked together and each carrying a security tag/label will each be subjected to a magnetic field component directed appropriately for magnetization/demagnetization of the respective tag/label irrespective of the particular orientation of the tag/label on the particular package. One embodiment uses spaced-apart coils (6-1, 6-2) with an enclosure (2) therebetween into which a rectangular crate/pallet can be placed, the enclosure (2) constraining the crate/pallet to a particular orientation within the enclosure, and the coils (6-1, 6-2) having a particular orientation with the enclosure.

### FIELD OF THE INVENTION

This invention relates to the activation and deactivation of magnetic components and more particularly, but not exclusively, to the bulk activation and deactivation of magnetically-activatable security tags.

### BACKGROUND OF THE INVENTION

A known method of security labelling for the purpose of monitoring package movements for example, using conventional magnetising and demagnetising techniques, involves using a magnetically-activatable tag which may be sensed remotely at radio frequency. The tag is effectively a tuned resonant circuit, comprising an inductive and a capacitive part, and resonates only at a specific frequency, hence the radio frequency detection system will only detect the specific tag, and only then if it is “switched on”. One known form of tag is made up of two parts, namely an inductive (magnetic) part and a capacitive (plastics) part. The magnetic part is made up of a strip of permanent magnet material, upon which a strip of soft (easily magnetised/demagnetised) magnetic material is placed. One or more layers of plastics material are placed on top of this arrangement to form the capacitive part. The dimensions and properties of the different layers determine the frequency at which the strip will resonate. Other forms of tags can be employed.

The basic idea therefore is to switch “on” the whole strip of the magnetic material by applying an external magnetic field large enough to magnetise the permanent magnet strip, and to switch “off” the same by applying a decaying reversing magnetic field of sufficient initial magnitude and of fine enough reversing step size to demagnetise the permanent magnet strip. The notions of “on” and “off” in this regard are relative since, in dependence upon the nature of the monitoring system, magnetisation for a particular form of tag may mean activation and for another de-activation and conversely for demagnetisation.

Conventional magnetising and demagnetising systems are known to be suitable for use in the above kind of method. Exemplary security tags and associated systems are available from Sensormatic Electronics Corporation of Florida, USA.

Typically, in a conventional magnetising system, a single coil is arranged so that the magnetic field that it generates is aligned with the security tag. The applied energy is supplied from a conventional capacitive discharge magnetiser. Application of unipolar magnetisation pulses in this way produces a field that is capable of magnetising the soft magnetic material only when the field is aligned therewith in a single direction. If tags are positioned at other angles relative to the applied field, full magnetisation of the tags cannot be guaranteed. Further this technique has limited utility in that it is designed to be carried out on tags in small volume and quantities to ensure proper alignment of the tags.

In a conventional demagnetising system, on the other hand, whereas a coil is again arranged such that the applied field is aligned with the security tag, the power applied either takes the form of a fixed A.C. signal or a decaying oscillatory signal. The fixed A.C. signal option requires the tagged item to be moved away from the peak A.C. field to provide a decaying field component at the tag, while the decaying oscillation principle allows stationary tagged items to be demagnetised. For the A.C. option, severe limitations in respect of power requirements necessitate that a small coil is used, and this constraint in coil size means that only very few items can be demagnetised at any one time. Furthermore, with a decaying oscillation demagnetisation sequence, the inductance of a coil with few winding turns is required to be high enough to achieve a long enough resonant rundown period, thus making it difficult to demagnetise the tags in an efficient way.

### OBJECTS AND SUMMARY OF THE INVENTION

It is thus the principal object of the present invention to provide a solution to or amelioration of the abovementioned drawbacks.

In broad terms, the invention resides in the provision of a magnetic activation/deactivation system which produces a sufficiently strong magnetic field component along each of a plurality of preselected orientations in a given assembly of variably-oriented tags such as to permit the magnetic activation/deactivation of tags in bulk. This cannot be achieved by using conventional systems.

According to a first aspect of the invention, there is provided a system for activating and/or deactivating an assembly of variably-oriented magnetic components, magnetically-activatable tags for example, said system comprising: means for generating and applying a magnetic field to said assembly, said means being oriented in relation to the components in said assembly to generate a magnetic field of sufficient magnitude in alignment with each predetermined orientation of each said variably-oriented component to permit each said component to be magnetically activated and/or deactivated.

The invention is particularly useful in the handling of crates or pallets loaded with tagged products wherein the tags will be oriented in one or more of three orthogonal planes, namely the X, Y and Z planes of the pallet. The magnetic field strength required to activate/deactivate magnetic tags in bulk, as when the tags are affixed to products stacked on a pallet, can range from 250 Oersted (20×10⁴Am⁻¹) for activation and 100 Oersted (80×10⁴Am⁻¹) for deactivation and is derived by applying a magnetic field of a predetermined strength oriented at a predetermined angle with respect to the pallet and with respect to the tag components. This aspect of the invention may be achieved by use of a plurality of spaced-apart Helmholtz coils, the arrangement being such as to enable the palleted tag components to be placed directly at the space between the coils. Alternatively, the same result could be obtained by use of a single coil appropriately oriented. In this arrangement, the tags can be magnetically activated/deactivated in bulk (that is, over a relatively large volume) by application of a single pulsed magnetisation or decaying stepped reversing demagnetisation cycle. Further, this aspect of the invention is envisaged to be used in combination with existing power management techniques of the kind described in GB-A-2 320 814, WO-A-98/29883 and GB Patent Application No. 0022852.8 the disclosures whereof are incorporated herein by reference. Basically, for deactivation a resonant discharge of a pre-charged capacitor bank may be used to drive the coils, and for activation the capacitor discharge would be interrupted after the first half-cycle.

A dual Helmholtz coil arrangement bears definite advantages for some situations in that the size of the whole assembly can be kept small size in relation to the size of the tag carrier/sample, namely the palleted tagged products. In this connection, it is to be noted that the tag carrier/sample can be easily inserted from one side of the arrangement into the space between the two coils so that the overall size of the assembly is enabled to be reduced. Further, a dual coil arrangement has a definite lightweight benefit, and because the arrangement is relatively small in size, a relatively small amount of energy is required to carry out a pulsed magnetisation/demagnetisation sequence, thus providing a more efficient and convenient mode of operation. Notwithstanding these advantages, a single solenoid alternative is attractive in certain situations, for example where the volume to be activated/de-activated departs from an isotropic cubic geometry in which case a single coil system is preferable as requiring lower power levels than a two-coil system. More complicated loading and coil-tilting procedures are required for single soil arrangements because of the more limited access that they provide, but as will be explained in the following this does not present a problem.

The above and further features of the invention are set forth in the appended claims and will be further described in the following by reference to the accompanying drawings which illustrate several exemplary embodiments.

### BRIEF DESCRIPTION OF THE DRAWINGS

In the drawings:

FIG. 1 is a perspective view of an embodiment of the invention;

FIG. 2 is an enlarged different view of the embodiment of FIG. 1;

FIG. 3 schematically indicates the dimensions of the embodiment of FIG. 1;

FIGS. 4 and 5 are further views of the embodiment of FIG. 1;

FIG. 6 is a schematic of another coil arrangement embodying the invention;

FIGS. 7a and 7b and FIG. 8 show schematically coil arrangements and their associated currents in respect of another embodiment of the invention; and

FIGS. 9(1) through 9(3) show various front and rear perspective views of another embodiment of the invention wherein the coil is pivotally mounted, the various views showing the embodiment in different conditions of use.

### DESCRIPTION OF THE EMBODIMENTS

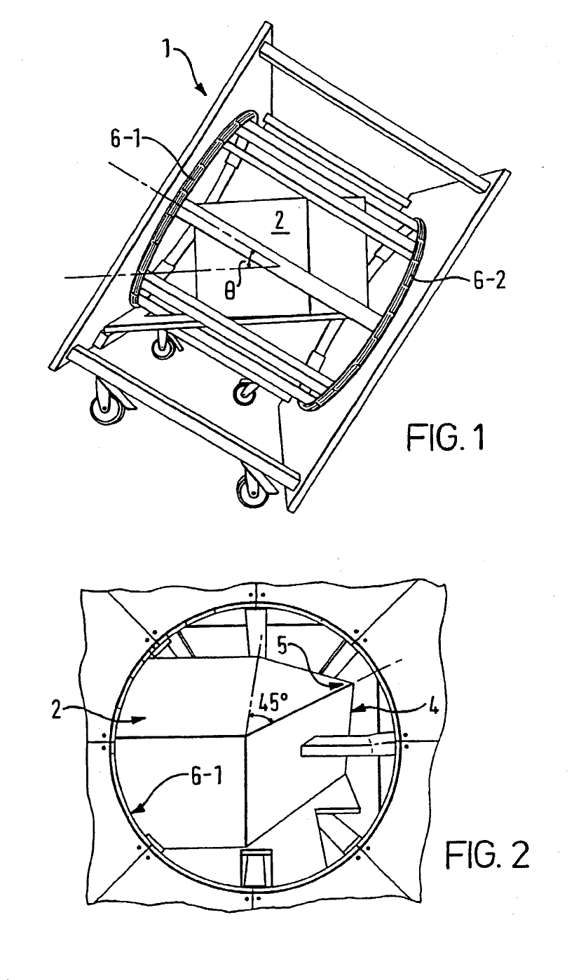

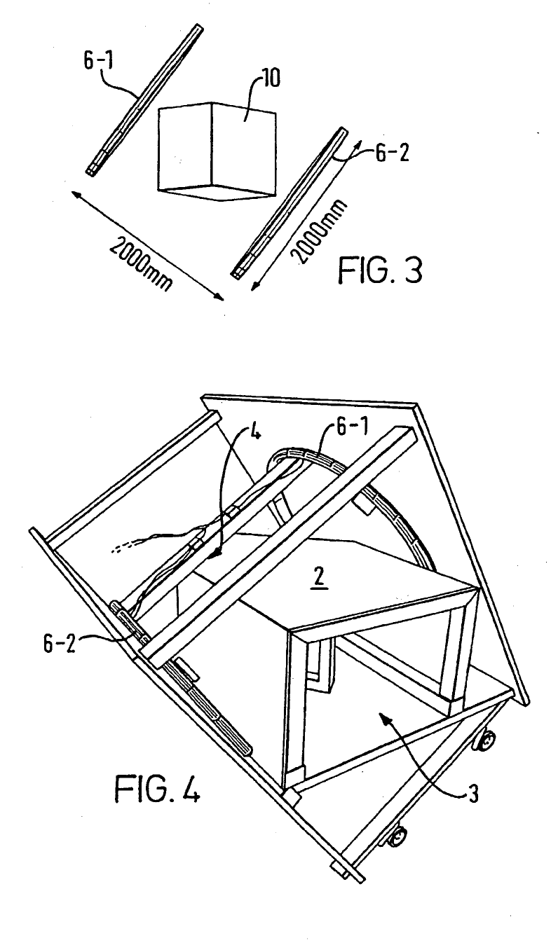

Referring first to FIGS. 1 to 5, there is shown therein an exemplary magnetic activation/deactivation assembly 1 embodying the present invention. The assembly 1 comprises a housing 2 into which there can be placed a crate or pallet (not shown) in or on which there are stacked a plurality of generally rectangular items, product cartons for example, each of which carries a magnetically-activatable security tag as aforementioned. As can best be seen in FIG. 3, the housing 2 is formed as an enclosure of rectangular cross-section which is open at one end 3 to admit the pallet and is closed at the opposite end 4 by an end wall which incorporates a right-angled bend 5 for nesting with a corner of the stacked pallet to constrain the pallet to a predetermined position and orientation within the enclosure. The housing 2 is mounted in a space between two Helmholtz coils 6-1 and 6-2 which, as shown, are mounted in planes which are inclined to the planar floor of the enclosure so that the magnetic field generated by the coils is applied to the pallet at a predefined angle of tilt (θ) relative to the horizontal floor of the housing.

Since the security tags are affixed to regularly shaped products, therefore they will be orientated to point along any one of the three main axes of the pallet, namely parallel to one set of sides of the pallet. En this way the orientation of each tag is known to be along one particular direction or along one of the two directions orthogonal to it.

We have found that a rectangular stacked pallet of dimensions 1200 mm(w)×800 mm(d)×1000 mm(h) can be magnetised by application of an in-line magnetic field component as low as 55 Oersted. By orienting the pallet in such a way that its [111] diagonal vector lies parallel with a sufficiently high applied field, the magnitudes of the field components in-line with each main axis of the pallet are made sufficiently high to activate and deactivate all tags within the pallet. To provide a single field component along the [111] vector of the loaded pallet, the coil arrangement is advantageously tilted relative to the pallet, as is shown, thus enabling easy handling and positioning of the pallet.

For powering the coils 6-1 and 6-2 to magnetize/demagnetize the security tags, the techniques described in GB-A-2 320 814 and WO-A-98/29883, the disclosures whereof are incorporated herein by reference, may be employed. Magnetization may be achieved with a single pulse of the coils 6-1, 6-2, whereas demagnetization may be achieved by use of a progressively decaying alternating magnetic field obtained by appropriately driving the coils.

FIG. 2 is an enlarged view of the housing 2, as viewed in the direction of the magnetic axis and looking onto the housing 2 through a circular opening in that wall of the FIG. 1 assembly which carries coil 6-1. The Figure shows the angled end 4 of the housing 2 which ensures that a nested pallet will be rotated by 45° relative to the open end 3 of the housing 2.

FIG. 3 is a schematic representation of the size of an assembly 1 as described above. The representation shows the two spaced-apart coils 6-1, 6-2 with a pallet 10 of tagged items placed with the appropriate orientation relative thereto as described above. In the Figure, the pallet 10 has dimensions 1200 mm(w)×800 mm(d)×1000 mm(h) and the coils for such an arrangement have a diameter of 2000 mm and are spaced apart by 2000 mm.

Two separate coils 6-1 and 6-2 are used in the above-described embodiment in order to minimize the size of the coils relative to the pallet of goods. The dual coil arrangement has the advantages of allowing the pallet to be easily inserted from the side of the assembly whilst maintaining a fairly uniform magnetic field distribution throughout the volume of the pallet.

FIG. 5 is a further view of the above-described embodiment of the invention, showing a dummy pallet 10 loaded into the housing 2 of the assembly 1 via the aperture 3. Because the coil arrangement 6-1, 6-2 is tilted at an angle θ relative to the pallet in one direction only, the pallet is additionally rotated in the horizontal plane relative to the coil arrangement through an angle of 45° (as is shown). This ensures that a correct angular alignment of the respective components is achieved during both magnetisation and demagnetisation cycles.

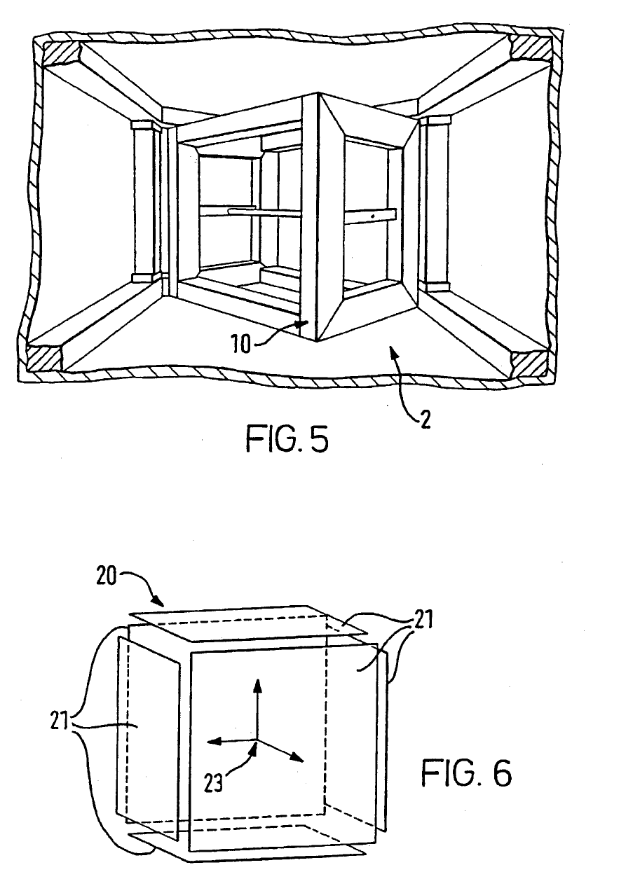

FIG. 6 shows a 3-coil pair arrangement 20 embodying the present invention. The 3-coil pair arrangement 20 comprises three sets of square paired coils 21 mounted perpendicular to each other. In use of this arrangement, the pallet of tagged goods (not shown) would be presented to the coils at the space 23 between the coils in such a way that the pallet faces are oriented perpendicularly to the coils. The axes of the pallet, and thus of the field direction, are as shown in the Figure.

In operation of the arrangement 20, the 3-coil pairs 21 are pulsed in sequence in order to effect a magnetisation/demagnetisation cycle. By applying a sequential firing pattern to each set of coils in turn, a field component can be separately applied to each axis of the pallet, in-line with the security tags. This approach enables all tags to be magnetised or demagnetised without the need to tilt the coils and pallet relative to each other. This arrangement also enables the pallet to be inserted into the coil assembly, with the aspect ratio of the coil assembly being the same as that of the pallet. The size of the coils can be minimised because the maximum dimension is larger than, but proportional to, the width of the pallet (namely 1200 mm for this embodiment).

In operation of the FIG. 6 embodiment in its magnetising mode one set of firings is needed, resulting in each orthogonal coil set receiving a unipolar pulse. This results in all tags being magnetised in all three orientations. In the demagnetising mode several sequential firing patterns are needed, with each subsequent reversed pulse applying less and less energy to the coil arrangement. This results in fill demagnetisation of all tags in all three orientations. As with the previously described embodiment, power handling techniques of the kind disclosed in GB-A-2 320 814 and WO-A-98/29883 are envisaged to be used with this arrangement.

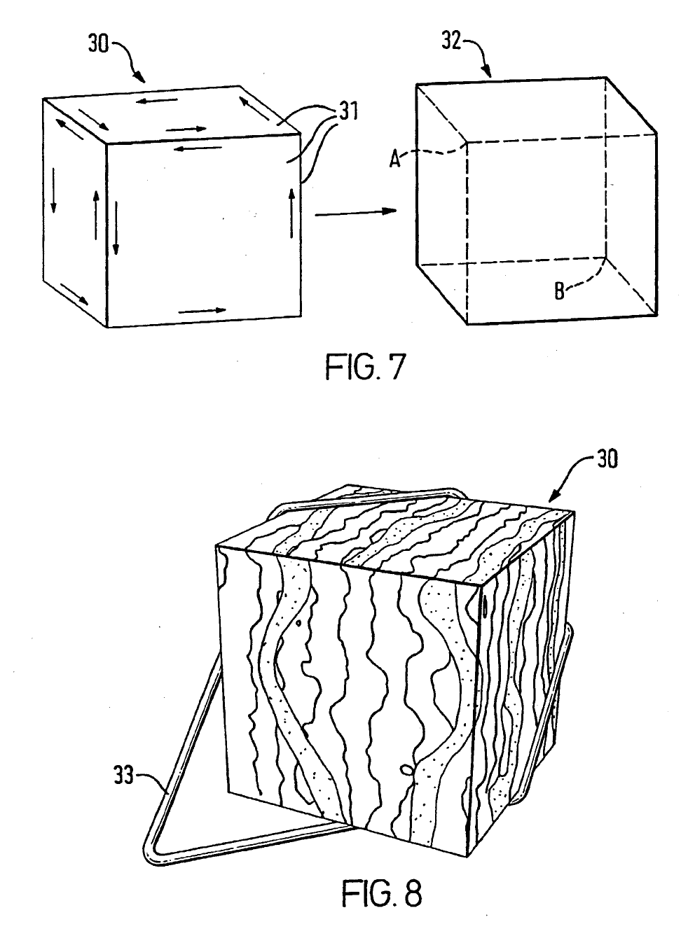

FIGS. 7 and 8 show schematically coil arrangements of a further embodiment of the invention In this embodiment, an alternative coil arrangement 30 is employed in which the field is applied perpendicularly to the faces of the pallet, with the coil(s) designed so as to represent the optimum minimum winding required. A single pulse or sequential firing of the coil(s) may be used to effect full magnetisation or demagnetisation of the tag components. As with the previously described embodiments, existing power handling techniques of the type described in GB-A-2 320 814 and WO-A-98/29883 are envisaged to be used with this kind of coil arrangement.

The diagram shown in FIG. 7a shows the direction of current 31 in each coil for a coil arrangement of the type described in FIG. 6 for example and also the associated effective current flow 31. FIG. 7b shows how this current can be reproduced by using a single winding 32. Note however that the field at points A and B is low due to their distance from the winding and to overcome this an optimised winding of the kind illustrated in FIG. 8 may be used. When a single coil approach is adopted the only access available is through the aperture of the coil. Furthermore the single coil would need to be tilted in a similar manner to the embodiment first described herein. Arrangements which achieve these requirements are described hereinafter.

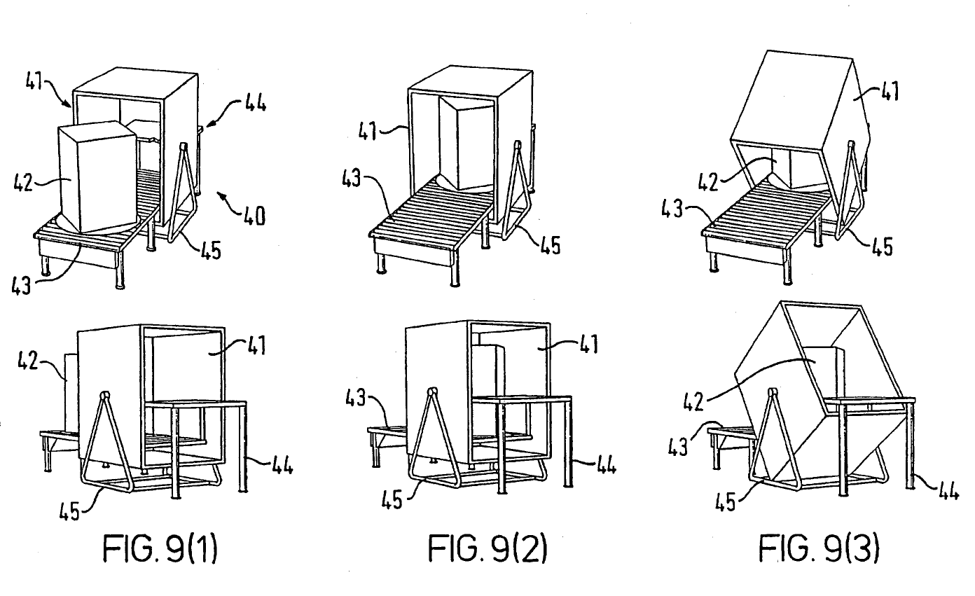

FIGS. 9(1) through 9(3) show front and rear perspective views of another embodiment 40 of the invention wherein a single coil is arranged to be pivotally movable in relation to a pallet of tagged goods on a conveyor in order to achieve the necessary orientations. As shown, the arrangement 40 comprises a single solenoid coil housed in a coil rotation frame 41 which is adapted to accommodate pallet 42 in use of the system, and an associated conveyor 43.

In operation of the arrangement 40, the pallet 42 of goods is first placed as shown in FIG. 9(1) onto the conveyor system 43 at an angle of 45° to the direction of travel of the conveyor by any convenient means. Thereafter, as shown in FIG. 9(2), the conveyor 43 is operated to drive the pallet 42 towards the solenoid coil in its rotation frame 41 which is in a vertical orientation. The pallet movement is stopped by means of a raised positioning block 44 and/or by means of stop switches (not shown), thereby ensuring a correct orientation between the pallet 42 and the coil.

The coil frame 41 is pivotally connected to an upstanding member 45 and this enables the solenoid coil carried by the frame 41 to tilt around the pallet 42 of goods at a predetermined angle (sin⁻¹ 1/ν3) relative to the horizontal. FIG. 9(3) shows the coil frame 41 in such tilted condition with the pallet 42 positioned inside. At this point, the magnetisation/demagnetisation sequence is initiated by application of a unipolar pulsed magnetic field for magnetising, or a series of decaying bipolar pulses for demagnetising, at the [III] unit vector to the pallet orientation. On completion of the magnetising or demagnetising sequence, the solenoid coil is then tilted back to its upright position, and the pallet is returned to its starting position on the conveyor for subsequent removal.

In this embodiment, to accommodate a pallet 42 of goods which fills a maximum volume of 1.27 m deep×1.473 m wide×2.185 m high, including product overhang, the solenoid coil might for example have external dimensions of 2.94 m long×3.28 m high×2.4 m wide and internal dimensions of 2.94 m long×3.08 m high×2.2 m wide.

Not shown in FIGS. 9(1) to 9(3) are the driver systems for the coil and associated control systems for determining the conveyor movement and the movement of the coil frame and for correlating these movements with the powering of the coil. These systems are within the skills of any skilled controls engineer and need not be described here.

Having described the invention in the foregoing by reference to specific embodiments, it is to be well understood that the invention is not limited to the embodiments described and that modifications and variations are possible without departure from the spirit and scope of the invention. For example, various coil arrangements of varying orientation and/or number may be used to produce the same effect as the invention. Furthermore, in the arrangement of FIG. 9, it might be preferred to have the conveyor extend through the coil frame 41 so that a processed pallet does not have to be reversed out of the system. A movable section of conveyor downstream of the coil frame could in this case be provided to accommodate the tipping movement of the coil frame. Other means of interfacing the pallet with the coil frame, could clearly be provided. For example, the coil frame could be mounted above the conveyor so as to be movable, on rails for example, downwardly towards the conveyor, and there could be a lifting mechanism associated with a particular region of the conveyor for raising a pallet located at that region to an elevation where it can be enveloped by the coil frame in its down position. An arrangement similar to that of FIG. 9 could also be utilized in which the coil frame housed two coils as in the first-mentioned embodiment.

1. Apparatus for the bulk activation/deactivation of magnetic tags/labels provided on products which are stacked so that the tags/labels adopt a finite number of preferential/orientations in the stack, the apparatus comprising coil means for generating a magnetic field having a predetermined field direction in an operational zone, and means provided in said zone for accepting such a stack of products with the stack oriented in a predetermined orientation relative to said magnetic field direction.

2. Apparatus as claimed in claim 1 wherein said coil means comprises first and second coaxial coils spaced apart from each other so as to define said operational zone therebetween.

3. Apparatus as claimed in claim 2 comprising an enclosure mounted in said operational zone for receiving a stack of products as aforesaid in a predetermined orientation with the enclosure, said enclosure being mounted in said predetermined orientation with the axis of said coils.

4. Apparatus as claimed in claim 3 wherein the enclosure provides a horizontal surface for receiving a stack of products as aforesaid, and the axis of said coils is inclined to the horizontal.

5. Apparatus as claimed in claim 3 or 4 for use with a rectangular stack of products and wherein the magnetic field direction is inclined with respect to the bottom of the stack by an angle of the order of 30°.

6. Apparatus as claimed in claim 5 wherein said angle is defined by the relationship θ=Sin⁻¹(1/√3).

7. Apparatus as claimed in any of claims 3 to 6 wherein said enclosure comprises means determining the orientation of a stack of products received therein about an axis perpendicular to the bottom of the stack.

8. Apparatus as claimed in claim 7 wherein said orientation determining means comprises abutment means in said enclosure constraining the stack, when correctly inserted, to a predetermined orientation.

9. Apparatus as claimed in claim 7 or 8 wherein the arrangement is such that a stack of products defining a square or substantially square footprint will, when correctly inserted, have a diagonal of said square footprint substantially at right angles to the axis of said coils.

10. Apparatus as claimed in claim 8 or 9 wherein said enclosure has a generally rectangular cross-section, one end is open for admittance of a stack of products as aforesaid to the enclosure, and the other end is closed by an angled wall defining said abutment means.

11. Apparatus as claimed in claim 1 wherein said coil means comprises a single coil.

12. Apparatus as claimed in claim 11 wherein said single coil is shaped so as to provide a substantially uniform magnetic field strength throughout a predetermined generally rectangular stack accommodation volume.

13. Apparatus as claimed in claim 11 or 12 wherein said single coil is mounted so as to be movable into operative relationship with a stack of products as aforesaid from a position enabling the stack to be introduced to and removed from said operational zone.

14. Apparatus as claimed in claim 13 wherein said coil is mounted in a pivotally movable frame defining said operational zone.

15. Apparatus as claimed in any of the preceding claims including means for conveying a stack of products as aforesaid to and from said operational zone.

16. Apparatus as claimed in claim 1 wherein said conveying means is arranged for movement of a stack of products as aforesaid to said operational zone and from said operational zone without reversal of the direction of movement.

17. Apparatus as claimed in any of the preceding claims wherein said operational zone is of such a size as to accommodate a stack of products as aforesaid having a volume of the order of 1×10⁹ mm³.

18. Apparatus as claimed in claim 17 wherein said operational zone is of such a size as to accommodate a stack of products as aforesaid having a volume of the order of 20×10⁹ mm³.

19. Apparatus as claimed in any of the preceding claims wherein the coil means is adapted to produce a magnetic field strength of the order of at least 4×10⁴ Am⁻¹ in each of said finite number of preferential orientations.

20. Apparatus as claimed in any of the preceding claims including drive means for powering said coil means in a pulsed magnetization mode and/or a diminishing alternating demagnetizing mode.

21. A method of activating/deactivating magnetic tags/labels by subjecting the same to a magnetic field having a predetermined alignment relationship with the tag/label structure, wherein, for bulk activation/deactivation of tags/labels affixed to products stacked with a predetermined multi-alignment relationship, a magnetic field is applied to the stacked products in a direction selected such that magnetic field components in directions corresponding to the alignment of products in the stack are generated which have sufficient magnetic strength to activate/deactivate the respective tags/labels.
